(19) United States
(12) Patent Application Publication
(10) Pub. No.: US 2017/0356331 A1
(43) Pub. Date: Dec. 14, 2017

(54) ELECTRIC COMPRESSOR

(71) Applicant: Valeo Systemes de Controle Moteur, Cergy Saint Christophe (FR)

(72) Inventors: Nicolas Martin, Cergy Saint Christophe (FR); Patrick Lebrasseur, Cergy Saint Christophe (FR); Mathieu Lallemant, Cergy Saint Christophe (FR); Franck Giraud, Cergy Saint Christophe (FR)

(73) Assignee: Valeo Systemes de Controle Moteur, Cergy Saint Christophe (FR)

(21) Appl. No.: 15/535,232

(22) PCT Filed: Dec. 11, 2015
(86) PCT No.: PCT/FR2015/053446

§ 371 Date: Aug. 16, 2017

(30) Foreign Application Priority Data
Dec. 12, 2014 (FR) 1462357

(51) Int. Cl. F02B 33/40; F02B 39/10; F02B 37/10; F04D 29/10; F04D 25/06; F04D 29/70; F04D 29/12; F16K 15/04; F16K 15/14

(52) U.S. Cl. CPC F02B 33/40; F04D 29/701; F02B 39/10; F02B 37/105; F04D 29/122; F04D 29/102; F04D 25/062; F16K 15/14; F16K 15/144; F16K 15/04

(57) ABSTRACT

The present invention relates to an electric compressor (9, 17) including a shaft (13) rotated by an electric motor by means of bearings (16), the shaft rotating a compressor wheel (14), the compressor (9) including two sealing segments (29a, 29b) mounted around the shaft (13) between the bearings (16) and the compressor wheel (14) and including a vent hole (31, 35, 38) for circulation of pollutant flows toward the outside of the compressor, the inlet of which is arranged between the two sealing segments, the vent hole including a non-return element (36).

The present invention relates to the field of electric compressors, and more particularly an electric supercharger compressor.

In the context of the invention, an electric compressor is a device used to supercharge a heat engine, working with an electric motor. More specifically, the compressor includes a compressor wheel driven by an electric motor.

The electric compressor is placed on the air intake line of an internal combustion engine, to supplement a turbocompressor. The electric compressor plays the same role as the turbocompressor, i.e., increasing the intake pressure of fresh gases in the engine, but is used in particular during transitional phases to offset the response time problems of the turbocompressor.

In order to protect the electric motor and its bearings from air that may contain various pollutants (oil, recirculated gases, etc.), a dynamic sealing system is placed between the compressor wheel and the electric motor. This system is made up of two segments. A vent hole, known from patent application UK1312334.4, is added between the two segments, in order to avoid the accumulation of any pollutants that may have traversed the first segment. For greater efficiency, the vent hole is connected to the inlet of the turbocompressor by a hose, which makes it possible to create a slight vacuum in order to bleed the vent hole.

In this type of device, the vent hole is thus connected to a zone that generally has an underpressure. This is necessary in order for the protection of the electric motor and its bearings to be effective. However, in certain operating cases, the pressure difference may reverse, i.e., the zone to which the vent hole is connected has an overpressure, which results in discharging the pollutants toward the dynamic sealing system.

The present invention therefore aims to offset one or several of the drawbacks of the devices of the prior art by proposing an electric compressor having an improved sealing system and thus making it possible to avoid pollution of the bearings.

To that end, the present invention proposes an electric compressor including a shaft rotated by an electric motor by means of bearings, the shaft rotating a compressor wheel, the compressor including two sealing segments mounted around the shaft between the bearings and the compressor wheel and including a vent hole for circulation of pollutant flows toward the outside of the compressor, the inlet of which is arranged between the two sealing segments, the vent hole comprising a non-return element.

This non-return element prevents any discharge toward the sealing compartment. More specifically, it prevents the polluted air having accumulated in the conduit during its circulation, going from the sealing compartment toward the outside, from being discharged toward the sealing compartment when the pressure difference is altered.

According to one embodiment of the invention, the non-return element is positioned on the circuit of the vent hole so as to limit the pollutant flow accumulation zone.

According to one embodiment of the invention, the non-return element is a valve positioned so as only to be able to open in the circulation direction going from the inlet of the vent hole toward the outlet of the vent hole.

According to one embodiment of the invention, the non-return element includes a movable obstructing member making it possible to allow the pollutant flow to pass in only one direction.

According to one embodiment of the invention, when the pollutant flow circulates from the outlet of the vent hole toward the inlet of the vent hole, the movable member is then pressed against a stop to obstruct the conduit of the vent hole.

According to one embodiment of the invention, the non-return element is a ball valve.

According to one embodiment of the invention, the non-return element is a reed valve.

According to one embodiment of the invention, the reed is a flexible membrane.

The invention also relates to a compressor according to the invention, in which the motor is a switched reluctance motor.

According to one embodiment of the invention, the compressor is an electric supercharger compressor.

Other aims, features and advantages of the invention will be better understood and will appear more clearly upon reading the description provided below, in reference to the appended figures, provided as an example and in which:

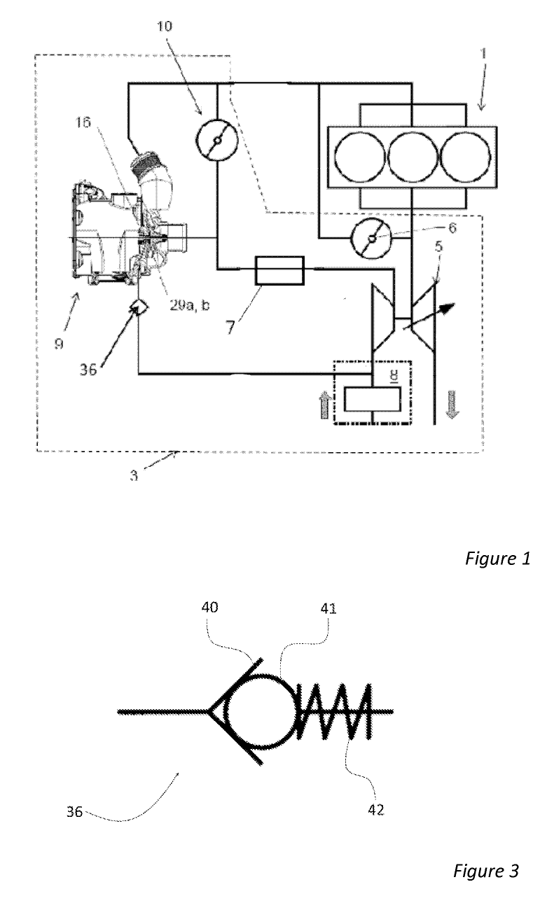

FIG. 1 is a schematic illustration showing a motor incorporating a system according to one embodiment of the invention,

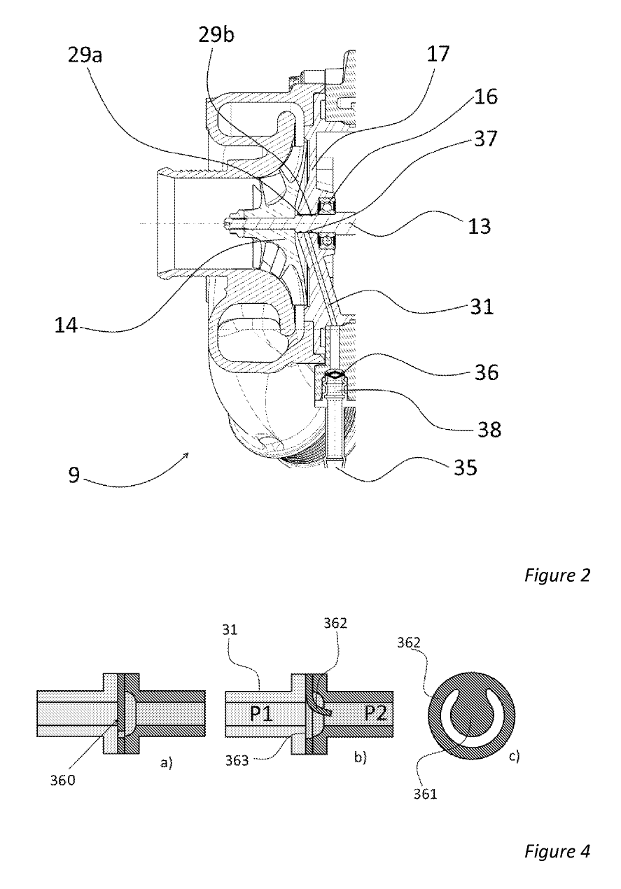

FIG. 2 is a sectional view of the compressor according to the invention,

FIG. 3 is a schematic illustration of a non-return element according to the invention,

FIGS. 4a, b and c are a schematic illustration of one alternative of the non-return element according to the invention, a) in the closed position, b) in the open position, c) a detail seen from the front.

The present invention relates to an electric compressor equipped with a sealing system. In the context of the invention, the dynamic sealing system is formed by at least one non-return element. More specifically, the sealing system is formed by least one vent hole associated with a non-return element.

In the context of the invention, the electric compressor refers to an air compressor, with or without volume displacement, and for example centrifugal or radial, driven by an electric motor, with the aim of supercharging a heat engine. According to one embodiment of the invention, the electric motor is a DC or AC asynchronous motor, or any other type of electric motor of the same type.

According to one embodiment of the invention, the electric motor is a switched reluctance motor (SRM).

According to one embodiment of the invention, the electric motor is a permanent magnet motor.

FIG. 1 illustrates an internal combustion engine with three cylinders 1 associated with a device 3 for supplying intake gas according to one embodiment of the invention. According to one embodiment of the invention, the supply device 3 (marked by a dotted line) comprises a turbocompressor 5.

According to one embodiment of the invention, the supply device 3 comprises an exhaust gas recirculation valve 6.

According to one embodiment of the invention, the supply device 3 comprises a supercharging air cooler 7.

According to one embodiment of the invention, the supply device 3 comprises an electric compressor 9 and a bypass valve of the compressor 10.

The turbocompressor 5 is supplied by the exhaust gases from the engine 1 and by the air arriving through an air intake 8. Part of the exhaust gases is recycled at the inlet of the engine 1 via an exhaust gas recirculation valve.

The gases from the compressor of the turbocompressor 5 are next cooled by the cooler 7, then supply the electric compressor 9.

According to another embodiment of the invention that is not shown, the cooler is positioned downstream from the electric compressor 9. The electric compressor 9 compresses the gases from the turbocompressor 5 and supplies the engine 1.

The electric compressor 9, illustrated in FIG. 2, comprises an electric motor 10 (not shown in FIG. 2), and bearings 16. The electric motor makes it possible to rotate a shaft 13 of the electric compressor via the bearings 16. The shaft 13 thus rotates the wheel 14 of the compressor 9. More specifically, one end of the shaft 13 is rotated by the electric motor, and another end of the shaft 13 rotates the wheel 14 of the compressor. The intermediate part of the shaft is protected by the body 17 of the compressor. This intermediate part of the shaft includes a sealing member, and more specifically dynamic sealing. This member is formed by a first sealing segment 29a positioned on the side of the wheel of the compressor and a second sealing segment 29b positioned on the side of the bearings 16. These segments serve to protect the bearings from pollution that may come from the wheel of the compressor.

Between these two sealing segments 29a, 29b is the inlet 37 of a vent hole 31. The vent hole 31 is added between the two segments in order to avoid the accumulation of any pollutants that have traversed the first segment 29a. According to one embodiment of the invention, for greater efficiency, the vent hole 31 is connected to the inlet of the turbocompressor. According to one embodiment, the vent hole 31 is connected to the turbocompressor for example via a hose, which makes it possible to create a slight underpressure in order to bleed the vent hole. The vent hole 31 thus traverses part of the compressor. According to one embodiment of the invention, the vent hole 31, more specifically the circuit of the vent hole, is extended outside the compressor. The vent hole 31 thus makes it possible to avoid pollution of the bearings 16 by making it possible to discharge pollutants owing to a pressure difference between the pressure P1 of the compartment formed between the two sealing segments 29a, 29b and the pressure P2 at the outlet of the vent hole 35. The pressure P1 between the two segments 29a, 29b is greater than the pressure P2 at the outlet 35 of the vent hole.

In certain usage scenarios of the compressor, the pressure P1 of the compartment formed between the two sealing segments 29a, 29b is lower than the pressure P2 at the outlet 35 of the vent hole. In this situation, the pollutants discharge toward the bearings 16 instead of being eliminated. This discharge may take place when the electric compressor is not activated and the compressed air at the outlet of the compressor of the turbocompressor passes through the bypass conduit.

In order to avoid this discharge phenomenon, the invention provides for positioning a non-return element 36 on the circuit of the vent hole 31. The passage for the air carrying the pollutants is then possible only in one direction. More specifically, the passage is only possible from the sealing compartment formed by the two sealing segments 29a, 29b toward the outlet 35 of the vent hole.

In the context of the invention, the non-return element 36 is positioned in the circuit of the vent hole 31, at the outlet of the compressor 9, as close as possible to the inlet 37 of the vent hole. Indeed, this prevents any discharge toward the sealing compartment. More specifically, this prevents the polluted air having accumulated in the conduit during its circulation, going from the sealing compartment toward the outside, from being discharged toward the sealing compartment when the pressure difference reverses.

According to one embodiment of the invention, the non-return element 36 is positioned in the circuit of the vent hole 31 so as to limit the pollutant flow accumulation zone.

In the context of the invention, an accumulation zone refers to the portion of the circuit of the vent hole 31 between the inlet 35 of the vent hole and the non-return element. According to one embodiment of the invention, the accumulation zone or portion is 10 cm maximum.

According to one embodiment of the invention, the non-return element is positioned in the portion 38 of the circuit of the vent hole situated at the outlet of the compressor 9.

According to one embodiment of the invention, the non-return element 36 is positioned near the inlet 37 of the vent hole.

According to one embodiment of the invention, the non-return element 36 is positioned at the inlet 37 of the vent hole.

In the context of the invention, the terms inlet and outlet are defined relative to the circulation direction of the flow, in the vent hole, going from the sealing compartment toward the outside of the compressor.

According to one embodiment of the invention illustrated in FIGS. 3 and 4, the non-return element 36 is a valve. The valve is positioned so as only to be able to open in one direction. More specifically, the valve 36 is positioned so as to open in the circulation direction of the pollutant flow going from the inlet 37 of the vent hole 31 toward the outlet 35 of the vent hole.

The non-return element 36 according to the invention includes an obstructing member 41, 362 movable or movable by deformation, making it possible to allow the pollutant flow to pass in one direction. When the pollutant flow circulates in the other direction, the movable member is then pressed against a stop 40, 363 or any other equivalent means making it possible to obstruct the conduit of the vent hole.

According to one embodiment of the invention, the valve is a ball valve illustrated in FIG. 3. The movable member is then the ball 41. According to this embodiment, the ball is pushed against the stop using a spring 42.

According to one embodiment of the invention, the valve is a reed valve, illustrated in FIG. 4. The movable member is then a reed or a flexible membrane 362. In this embodiment illustrated in FIG. 4, the movable member is formed by a solid washer 362, the central part 361 of which is circularly cut, over an angle smaller than 360°, so as to be able to move on either side of its contour. This washer is pressed against a stop 363 positioned in the conduit of the vent hole. The stop is wide enough for the cut central part to bear on the stop in a circulation direction of the pollutant flow. More specifically, the central part bears on the stop in a circulation direction going from the outside of the vent hole toward the sealing compartment.

In all cases, irrespective of the embodiment of the invention, the movable member is configured such that:
when the pressure P1 from the compartment formed between the two sealing segments 29a, 29b is lower than the pressure P2 at the outlet 35 of the vent hole, the valve 36 is closed, i.e., the flow no longer circulates,
when the pressure P1 of the compartment formed between the two sealing segments 29a, 29b is above the pressure P2 at the outlet 35 of the vent hole, the valve 36 is open, i.e., the flow circulates.

The opening of the non-return element 36 is determined as a function of an initiation pressure Pdec1. This initiation pressure is determined such that:
If P2>P1−Pdec1, then the valve is closed,
If P2<P1−Pdec1, then the valve is open.

According to one embodiment of the invention, Pdec1 is as low as possible, and for example comprised between 10 and 20 mbar.

The compressor according to the invention is thus configured so as to protect the bearings, and also the electric motor, from pollutants such as oil, recirculated gases or any other pollutants.

The scope of the present invention is not limited to the details provided above and allows embodiments in many other specific forms without going outside the scope of application of the invention. Consequently, the present embodiment must be considered as an illustration, and can be modified without going outside the scope defined by the claims.

1. An electric compressor comprising:
a shaft rotated by an electric motor by bearings, the shaft rotating a compressor wheel;
two sealing segments mounted around the shaft between the bearings and the compressor wheel; and
a vent hole for circulation of pollutant flows toward the outside of the compressor, an inlet of which is arranged between the two sealing segments,
wherein the vent hole includes a non-return element.

2. The compressor according to claim 1, wherein the non-return element is positioned on the circuit of the vent hole so as to limit the pollutant flow accumulation zone.

3. The compressor according to claim 1, wherein the non-return element is a valve positioned so as only to be able to open in the circulation direction going from the inlet of the vent hole toward the outlet of the vent hole.

4. The compressor according to claim 1, wherein the non-return element includes a movable obstructing member that allows the pollutant flow to pass in only one direction.

5. The compressor according to claim 4, wherein when the pollutant flow circulates from the outlet of the vent hole toward the inlet of the vent hole, the movable member is then pressed against a stop to obstruct the conduit of the vent hole.

6. The compressor according to claim 1, wherein the non-return element is a ball valve.

7. The compressor according to claim 1, wherein the non-return element is a reed valve.

8. The compressor according to claim 7, wherein the reed is a flexible membrane.

9. The compressor according to claim 1, wherein the motor is a switched reluctance motor.

10. The compressor according to claim 1, wherein the compressor is a heat engine electric supercharger compressor.
